(19) United States
(12) Patent Application Publication
(10) Pub. No.: US 2005/0079327 A1
(43) Pub. Date: Apr. 14, 2005

(54) Baby burp cloth and diaper and method

(76) Inventor: Christina Stiles, Nicasio, CA (US)

Correspondence Address: CHARLES LOUIS THOEMING, 1390 WILLOW PASS ROAD, SUITE 1020, CONCORD, CA, 94520, US

(21) Appl. No.: 10/683,824

(22) Filed: Oct. 10, 2003

(51) Int. Cl. B32B 3/00

(52) U.S. Cl. 428/195.1

(57) ABSTRACT

A reusable baby diaper or baby burp cloth which masks stains by use of one or more colors and one or more color fast designs or patterns permanently set in the cloth fibers.

### CROSS-REFERENCES TO RELATED APPLICATIONS

None.

### STATEMENT REGARDING FEDERALLY SPONSORED RESEARCH OR DEVELOPMENT

None.

### REFERENCE TO A MICRO-FICHE APPENDIX

None.

### BACKGROUND OF THE INVENTION

1. Field of the Invention

This invention relates generally to reusable baby diapers and baby burp cloths, and more particularly to a method for masking the degree of noticeable staining of such items after repeated use.

2. Description of the Related Art including Information Disclosed under 37 C.F.R. 1.97 and 1.98

A search of the prior art located the following U.S. patents which are believed to be representative of the present state of the prior art: U.S. Patent Publication No. US2002/0166183 A1, published Nov. 14, 2002, U.S. Pat. No. 1,199,745, issued Sep. 26, 1916, U.S. Pat. No. 3,702,610, issued Nov. 14, 1972, U.S. Pat. No. 6,261,674, issued Jul. 17, 2001, U.S. Patent Publication No. US2002/0127385 A1, published Sep. 12, 2002, International Patent Publication No. WO 02/084004 A2, published Oct. 24, 2002, U.S. Pat. No. 6,348,258 B1, issued Feb. 19, 2002, U.S. Pat. No. 3,907,499, issued Sep. 23, 1975, and International Patent Publication No. WO 99/33656, published Jul. 8, 1999

### BRIEF SUMMARY OF THE INVENTION

The present invention provides an improved reusable baby burp cloth and diaper which masks staining from repeated use without the necessity for bleaching or other extreme cleansing practices. Reusable burp cloths and diapers in the art are bleached cotton or similar materials which, when exposed to the secretions of a baby, retain unsightly stains and stain boundaries regardless of the regular washing practices employed to cleanse the cloths or diapers. Extreme bleaching techniques or repeated washing cycles tend to destroy the integrity of the materials, leading to lessened absorbency or fraying at the edges of the material. Bleaching also leaves harsh residue in the cloths which can irritate a baby's sensitive skin when in direct contact. Additionally, the bleached cotton materials in the art do not mix or blend with clothing under or around the materials, further drawing attention to the materials and any unintended disclosure resulting from such heightened scrutiny.

It is an objective of the present invention to provide a reusable baby burp cloth or diaper which masks stains incumbent thereon from repeated use.

It is a further objective of the present invention to provide a reusable baby burp cloth or diaper which does not require repeated washing or bleaching practices to treat staining.

It is yet another objective of the present invention to a reusable baby burp cloth or diaper that blends or mixes with articles of clothing under or surrounding the cloth or diaper.

It is still another objective of the present invention to provide a reusable baby burp cloth or diaper which can be decoratively and thematically embossed.

Other features, advantages, and objects of the present invention will become apparent with reference to the following description and accompanying drawings.

### BRIEF DESCRIPTION OF DRAWINGS

There are no drawings or figures in this specification.

### DETAILED DESCRIPTION OF THE INVENTION

The present invention provides an improved reusable baby burp cloth and diaper which masks staining from repeated use without the necessity for bleaching or other extreme cleansing practices. As part of growing concern for environmentally friendly and ecologically responsible practices, consumers are favoring reusable materials, including diapers and burp cloths. Reusable burp cloths and diapers in the art are bleached cotton or similar materials which, when exposed to the secretions of a baby, retain unsightly stains and stain boundaries regardless of the regular washing practices employed to cleanse the cloths or diapers. Extreme bleaching techniques or repeated washing cycles tend to destroy the integrity of the materials, leading to lessened absorbency or fraying at the edges of the material. Additionally, the bleached cotton materials in the art do not mix or blend with clothing under or around the materials, further drawing attention to the materials and any unintended disclosure resulting from such heightened scrutiny.

The improved method for masking stains on a reusable baby diaper or baby burp cloth of the present invention comprises first providing a fabric material which is white or otherwise not color treated. The preferred embodiment of the present invention uses natural, unbleached cotton having at least three plies as the fabric material. The several plies of cotton of the preferred embodiment are overlapped and sewn together to create an extra absorbent padded center section secured by two vertical binding lines on each side consistent with diaper construction in the art. The size of the fabric material of the preferred embodiment is 11″ by 17″; however, any sized material can be used in the method and later sized for the appropriate dimensional use. An absorbent, fibrous web with at least three dimensions is also appropriate as the fabric material of the present invention. In fact, any absorbent body comprising a matrix of substantially hydrophillic fibers having therein a distribution of high-absorbency materials will suffice as the fabric material of the present invention. Examples of suitable fibers known in the art are organic fibers such as cellulosic fibers and the like, synthetic fibers made from wettable thermoplastic polymers such as polyester or polyamide, or synthetic fibers composed of nonwettable polymer such as polypropylene fibers. Additionally, absorbent gelling material known in the art such as alkali metal and ammonium salts of poly(acrylic acid) and poly(methacrylic acid), poly(acrylamides) and poly(vinyl ethers) can be added to the fibers.

The next step in the method of the present invention is deciding upon or providing at least one predetermined pattern or design for imprinting the fabric material. The pattern or design may be geometric, repeating, thematic, or archival—depending upon the intention of the user. In this manner, consideration of the patterns, designs, and/or colors of garments which will be in proximity to the fabric material once it is in place for use as either a baby burp cloth or baby diaper is also a sub-step of this step of the present invention.

After the patterns and designs have been selected, the material fibers are color treated with at least one color fast dye treatment consistent with the predetermined pattern or design. Any color fast methods known in the art are sufficient to complete this step using dyes such as Procion®, vegetable dyes, fine powders of citrus fruits, and the like. The known methods in the art for pattern coloring, such as batik, silk-screening, tie-dying, soda-soak, cold batch, or after fix and the like, are suitable for this step of the present invention. If complex patterns or designs are desired, the steps of providing a pattern or design and color treating the pattern or design are repeated until the material is completely colored consistent with the wishes of the user. All patterns and designs provided consistent with the method of the present invention camouflage stains created by use of the fabric material as a baby diaper or baby burp cloth.

As provided by the following method, the improved reusable baby burp cloth and diaper masks stains resulting from baby excretion, defecation, or secretion while the cloth or diaper is in use. After regular washing procedure, without the necessity of bleaching or repeated wash cycles, the reusable cloth is presentable for public use without concern for unsightly staining which is novelly and effectively masked by the method and materials of the present invention. For example, the brightly colored patterns and designs of the method of the present invention are particularly effective in masking the staining from regurgitated baby formulas or breast milk. Additionally, the burp cloth or diaper can be selectively coordinated by the user to match the color or patterns of the user's garments worn with or in proximity to the treated fabric material, the degree of public exposure occasioned by the specific use of the treated fabric material, or a particular holiday or special celebration theme appropriate to the user. Finally, it has been found in testing the proto-types of the present invention that the bright colors and interesting designs provided by the method of the present invention proves to be intriguing to infants and toddlers.

While the invention has been described in detail with respect to specific embodiments thereof, it will be appreciated that those skilled in the art, upon obtaining an understanding of the foregoing, will readily conceive of alterations to variations or equivalents to these embodiments. It will also be understood that the method claims are not intended to be limited to the particular sequence in which the method steps are listed therein, unless specifically stated therein or required by description set forth in the steps. Accordingly, the scope of the present invention should be assessed as that of the appended claims and any equivalence thereto.

1. An improved method for masking stains on a reusable baby diaper or baby burp cloth comprising the steps of:
providing a fabric material which is white or otherwise not color treated;
providing at least one predetermined pattern or design for imprinting the material;
color treating the material fibers with at least one color fast dye treatment consistent with the predetermined pattern or design;
repeating steps of providing a pattern or design and color treating the pattern or design until the material is completely colored consistent with the desired pattern or design.

2. The method of claim 1, wherein the fabric material further comprises cotton having at least three plies.

3. The method of claim 2, wherein the fabric material is suitable for and further comprises a baby diaper.

4. The method of claim 3, wherein the predetermined pattern is thematic.

5. The method of claim 2, wherein the fabric material is suitable for and further comprises a baby burp cloth.

6. The method of claim 5, wherein the predetermined pattern is thematic.

7. The method of claim 1, wherein the fabric material further comprises an absorbent, white, three dimensional fibrous web.

8. The method of claim 7, wherein the fabric material is suitable for and further comprises a baby diaper.

9. The method of claim 8, wherein the predetermined pattern is thematic.

10. The method of claim 7, wherein the fabric material is suitable for and further comprises a baby burp cloth.

11. The method of claim 10, wherein the predetermined pattern is thematic.

12. An improved baby diaper comprising:
an absorbent, white, three dimensional fibrous web; and
at least one color fast dye applied to the fibrous web in at least one predetermined design or pattern wherein the applied color fast dye and pattern or design tend to mask or otherwise diminish the effect of stains on the diaper.

13. The diaper of claim 12, wherein the predetermined pattern is thematic.

14. An improved baby burp cloth comprising:
an absorbent, white, three dimensional fibrous web; and
at least one color fast dye applied to the fibrous web in at least one predetermined design or pattern, wherein the applied color fast dye and pattern or design tend to mask or otherwise diminish the effect of stains on the burp cloth.

15. The burp cloth of claim 14, wherein the predetermined pattern is thematic.

16. An improved baby diaper comprising:
a white cotton material having at least three plies; and
at least one color fast dye applied to the cotton material fibers in at least one predetermined design or pattern wherein the applied color fast dye and pattern or design tend to mask or otherwise diminish the effect of stains on the diaper.

17. The diaper of claim 16, wherein the predetermined pattern is thematic.

18. An improved baby diaper comprising:
a white cotton material having at least three plies; and
at least one color fast dye applied to the cotton material fibers in at least one predetermined design or pattern, wherein the applied color fast dye and pattern or design tend to mask or otherwise diminish the effect of stains on the diaper.

19. The diaper of claim 18, wherein the predetermined pattern is thematic.
